(19) United States
(12) Patent Application Publication
(10) Pub. No.: US 2025/0306819 A1
(43) Pub. Date: Oct. 2, 2025

(54) METHOD OF PROCESSING PRINT JOB, INFORMATION PROCESSING APPARATUS, IMAGE FORMING SYSTEM, AND MEDIUM

(71) Applicant: CANON KABUSHIKI KAISHA, Tokyo (JP)

(72) Inventor: Ryo Oikawa, Kanagawa (JP)

(21) Appl. No.: 19/083,764

(22) Filed: Mar. 19, 2025

(30) Foreign Application Priority Data
Mar. 27, 2024 (JP) 2024-052129

(51) Int. Cl. G06F 3/12

(52) U.S. Cl. CPC G06F 3/1222; G06F 3/1238; G06F 3/1239; G06F 3/1253; G06F 3/1267

(57) ABSTRACT

An information processing apparatus has a communication device. The information processing apparatus holds purpose information associated with identification information related to a terminal device; receives the identification information related to the terminal device from the terminal device; transmits purpose information associated with the received identification information to the terminal device as a purpose selectable in the terminal device; and receives and stores, from the terminal device, a print job associated with a selected purpose.

### BACKGROUND OF THE INVENTION

### Field of the Invention

The present invention relates to printing in a virtual multifunction printing device (virtual MFP). In particular, the present disclosure relates to a method of processing print job, an information processing apparatus, an image forming system, and a medium in the context of multiple jobs in which a user performs work in a plurality of companies.

### Description of the Related Art

In recent years, management of who is to be charged when printing in business is executed has become complicated due to people working for two or more organizations and due to the location at which a multifunction peripheral (or multifunction printing device) or a printer is used being changed due to a change in the work location. There is an increasing demand to be able to freely perform printing from any printer inside and outside the company, including those at home, without taking into consideration management regarding charging.

As a method for solving this problem, a virtual MFP platform service (hereinafter referred to as a virtual MFP) has been proposed. This is a type of cloud print service in which a print job is input to an image forming device via a cloud, and is a system in which a virtual multifunction peripheral in which a plurality of billing destinations for charging related to printing are mixed is set and billing can be made for each billing destination. The virtual MFP is characterized in that when a user submits a print job to the virtual MFP using a mobile terminal or the like, the user designates the purpose of the print job. As the purpose designated here, in a case where the user works a plurality of jobs, there are cases where the user designates the purpose as work for the respective company that they are working for or selects personal printing. The multifunction peripheral or the printer that can use the virtual MFP may be owned by an individual in addition to an organization such as a company. In a case where the user desires to print a job submitted to the virtual MFP, the user logs into a service account of the virtual MFP from a multifunction peripheral or a printer that can use the virtual MFP, and selects a job desired to be printed from a list of print jobs submitted by the user himself/herself to execute printing. When printing is executed, the virtual MFP executes a charging process according to the purpose associated with the print job. For example, in a case where a print job in which the user selects work for a company A to which the user belongs as the purpose is printed by a multifunction peripheral in a convenience store, the cost required for printing is billed to the company A, and the sales are counted as those of the convenience store that manages the multifunction peripheral.

In the virtual MFP, when the user logs into the image forming device and displays the print job list, all the print jobs submitted by the user to the virtual MFP are displayed regardless of the purpose of use. Furthermore, regardless of where the image forming device is installed, the print jobs for all the purpose of use are displayed.

Japanese Patent Laid-Open No. 2014-049059 describes setting a purpose of use, such as personal use or business use, in print settings for printing when working at home. Furthermore, it describes that, in a case where the output printer is owned by a company, the purpose of use of the print job selected on the print setting screen is initially displayed in a state where “business use” is already selected. On the other hand, Japanese Patent Laid-Open No. 2014-049059 describes that in a case where the output printer is owned by the user himself/herself, the purpose of use of the job is initially displayed in a state where “personal use” is already selected.

However, in the method of Japanese Patent Laid-Open No. 2014-049059, it is necessary to designate in advance a printer for output at the time point of job input. In addition, displaying in a state where business use or personal use is already selected is merely the initial state of the print setting screen, and a specific purpose cannot be forced.

The user can submit a print job to the virtual MFP using a mobile terminal such as a smartphone. At this time, the purpose of the print job may be self-evident. For example, if the mobile terminal is supplied from an organization to which the user belongs, a file that can be accessed from the terminal is related to business, and a print job submitted therefrom is considered to be for business purpose. In such a case, it is troublesome for the user himself/herself to select the purpose of use as a print job for business. In addition, there is a possibility that the wrong purpose of use will be set, and as a result, correct billing cannot be performed.

### SUMMARY OF THE INVENTION

In the invention of the present application, when a user submits a print job to a virtual MFP, a purpose of use of the print job corresponding to a terminal that submits the print job is appropriately set.

According to one aspect of the present invention, there is provided an information processing apparatus comprising: a communication device; at least one memory storing instructions; and at least one processor that is in communication with the at least one memory and that, when executing the instructions, cooperates with the at least one memory to execute processing, the processing including holding purpose information associated with identification information related to a terminal device; receiving the identification information related to the terminal device from the terminal device; transmitting purpose information associated with the received identification information to the terminal device as a purpose selectable in the terminal device; and receiving and storing, from the terminal device, a print job associated with a selected purpose.

According to the present invention, when a user submits a print job to a virtual MFP, a purpose of use of the print job corresponding to a terminal that submits the print job can be appropriately set.

Further features of the present invention will become apparent from the following description of exemplary embodiments with reference to the attached drawings.

### BRIEF DESCRIPTION OF THE DRAWINGS

FIG. 1 is a basic configuration diagram of a virtual MFP system.

FIG. 2 is a block diagram illustrating an example of a software configuration of the virtual MFP.

FIG. 3 is a sequence diagram for displaying a job list of the virtual MFP.

FIG. 4 is a block diagram illustrating a hardware configuration example of the virtual MFP.

FIG. 5 is a sequence diagram for displaying a print job list according to a first embodiment.

FIG. 6 is a flowchart for displaying a print job list according to the first embodiment.

FIG. 7 is a sequence diagram for displaying a print job list according to a second embodiment.

FIGS. 8A through 8F are diagrams illustrating an example of table groups referred to in the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

A first embodiment of the present invention will be described. In the first embodiment, an example will be described in which a terminal that inputs a print job to a virtual MFP is identified, and a job input function of setting an appropriate purpose of use and a job display control function of controlling display of a job list for the purpose of use set in the input print job are included. Note that in the following description, the purpose of use may be referred to as “application”, but in the present embodiment, both are used synonymously.

### System Configuration

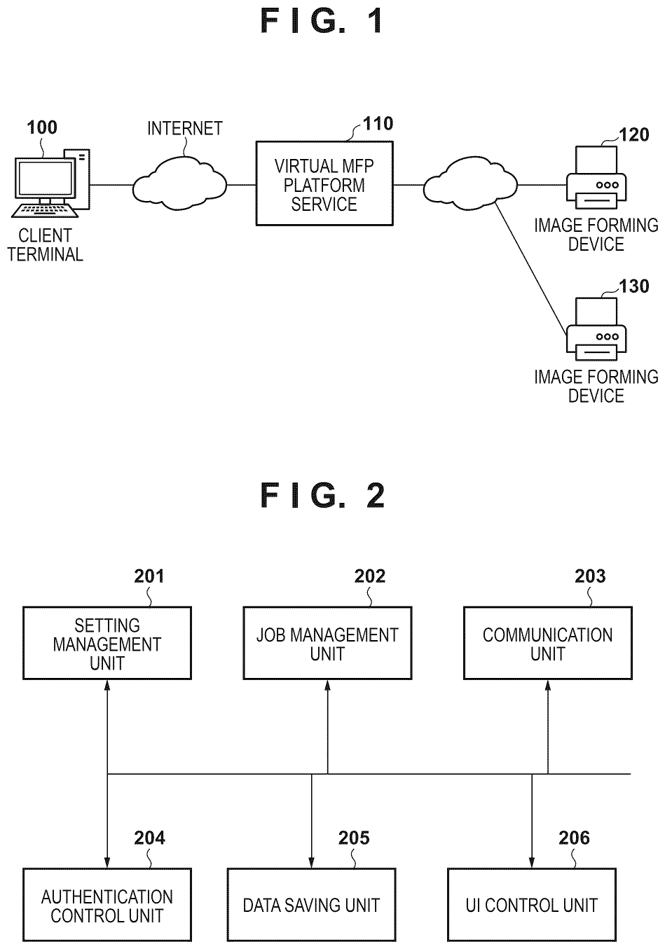

FIG. 1 illustrates a system configuration of an image forming system according to an embodiment of the present invention. The image forming devices 120 and 130 are image forming devices configured to acquire a print job from a virtual multifunction printing device (virtual MFP) and execute a printing process. Note that in the following description, the image forming device 120 is used as a representative of image forming devices, but the same applies to the image forming device 130. A virtual MFP platform service 110 receives a print job from a client terminal 100 and transmits a print job list to the image forming device 120. The virtual MFP platform service 110 is also referred to as a virtual MFP 110. In addition, the virtual MFP 110 transmits the print job selected by the user who operated the image forming device 120 to the image forming device 120. The client terminal 100 is a client terminal 100 configured to input a print job to the virtual MFP 110.

Each component described above is communicatively connected by a network. The network is, for example, any one of a LAN such as the Internet, a WAN, a telephone line, a dedicated digital line, and an ATM. Alternatively, the communication network is a communication network realized by a combination thereof. The network merely needs to be able to transmit and receive data.

### Hardware Configuration

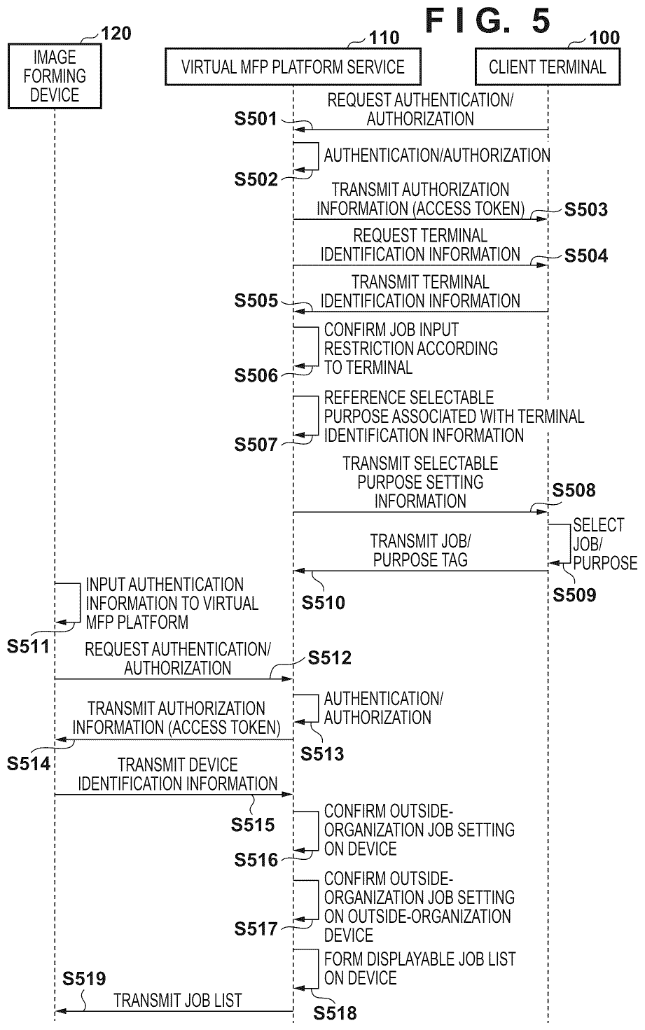

FIG. 4 is a block diagram illustrating a hardware configuration example of the image forming device 120 illustrated in FIG. 1. A hardware configuration of a general information processing apparatus can be applied to the client terminal 100 and the virtual MFP 110 according to the present embodiment. That is, the client terminal 100 and the virtual MFP 110 have the configuration of the information processing apparatus in which a scanner unit 408 and a printer unit 409 are removed from the configuration of FIG. 4.

A CPU 401 is a processor configured to comprehensively control the entire hardware, control each unit connected to the bus 400, and execute each function such as, for example, printing or scanning. A ROM 402 is a data read-only memory configured to store, for example, a basic control program of the image forming device. A RAM 403 is a data-readable/writable memory and is used, for example, as a working memory of the CPU 401.

A storage unit 404 is used as a storage area for temporary data or permanent data during execution of each program. For example, an HDD is often used as the storage unit 404, but the storage unit may be a device that can read/write data by loading a SSD or an external medium such as a CD, a DVD, or a memory card.

A communication unit 405 connects the image forming device 120, the virtual MFP 110, and the client terminal 100 to a LAN or the Internet, and enables data communication between the devices by, for example, TCP/IP.

An input unit 406 is an operation unit for accepting input operation of characters and data by the user. Examples thereof include a keyboard, a mouse, physical keys, and a touch panel.

A display unit 407 is a device for displaying various screens, and is, for example, a liquid crystal display or a touch panel. The user gives an instruction via the input unit 406 on the user interface screen displayed on the display unit 407, and gives a job execution instruction to the virtual MFP 110.

In addition, in the image forming device 120, the scanner unit 408 configured to read an image and generate image data, and the printer unit 409 configured to form an image on a print medium based on print data or the like are connected to the bus 400.

### Software Configuration

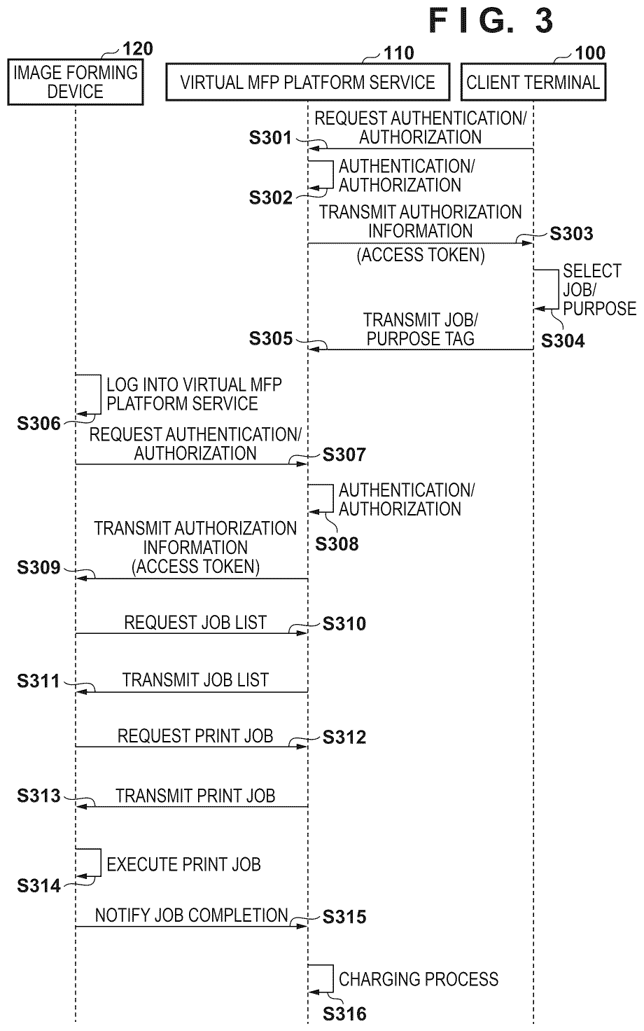

FIG. 2 is a block diagram illustrating an example of a software configuration of the virtual MFP 110 according to the first embodiment. The software configuration illustrated in FIG. 2 is realized by, for example, the CPU 401 loading a program stored in the ROM 402 into the RAM 403 and executing the program. A line connecting the blocks indicates communication between the functional blocks.

A setting management unit 201 stores settings related to various functions of the virtual MFP 110 in the storage unit such as the RAM 403 and the storage unit 404, and reads the settings related to various functions from the storage unit. The job management unit 202 saves the print job received from the client terminal 100 in a data saving unit 205. The job management unit 202 also transmits a list of print jobs (job list) saved in the data saving unit 205 to the image forming device 120. The job list transmitted to the image forming device may include only the print job of the user who requested the job list. Furthermore, when an acquisition request for a print job is received from the image forming device 120, the corresponding print job is specified from the data saving unit 205 and transmitted to the image forming device 120.

The communication unit 203 controls communication via a connected network or the like. An authentication control unit 204 controls, for example, authentication of a user who logs in from the client terminal 100 or a user who logs in from the image forming device 120. The authentication itself may be performed by an authentication server (not illustrated). An UI control unit 206 controls a UI screen displayed on the display unit 407 and user input by the input unit 406. In the virtual MFP 110, an information processing apparatus such as a server on which the virtual MFP is executed may not have a user interface, but control may be performed to remotely provide a user interface to another apparatus such as the client terminal 100.

### Application Information Table

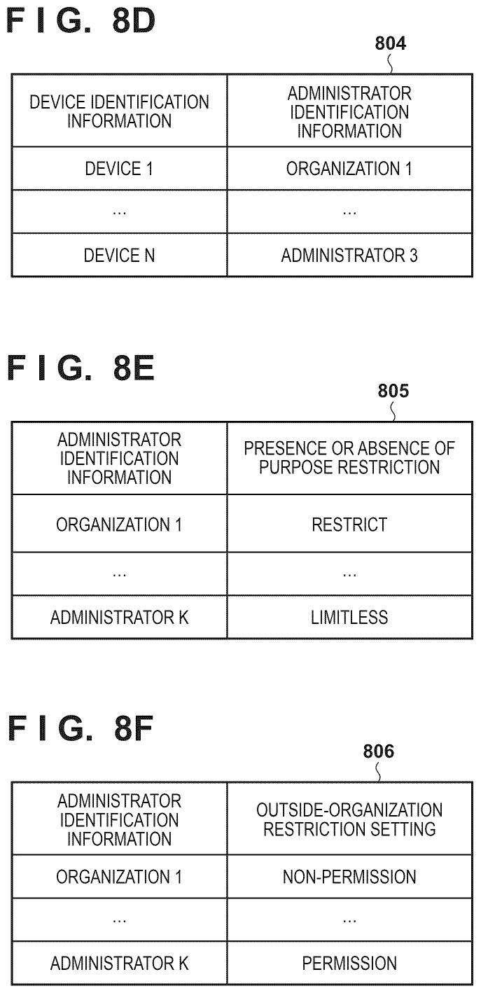

An example of a purpose information table 801 included in the virtual MFP 110 is shown in FIG. 8A. Tables other than the purpose information table 801 are not used in the present embodiment. In the purpose information table 801, administrator information indicating a charging destination is registered in association with purpose information indicating the purpose. The purpose information table 801 may be saved in, for example, the setting management unit 201 or the data saving unit 205. Note that the administrator information is not necessarily an organization (hereinafter, referred to as a tenant) such as a company that has made a usage contract for the virtual MFP. For example, the virtual MFP 110 is such that the user account of the virtual MFP 110 is assigned to each user belonging to the tenant who has made the usage contract therefor. In this case, the fee used by the logged-in user may be billed to the tenant, and the purpose and the charging destination designated for each tenant may be designated in the purpose information table 801. The amount of money for each charging destination may be provided to the contractor for each tenant, and may be used, for example, for budget management for each charging destination such as a department.

The purpose information table 801 may be registered for each tenant that uses the virtual MFP 110. A tenant is a contractor who can use the virtual MFP 110, and a user account may be provided for each tenant. Note that the tables and settings illustrated in FIGS. 8A through 8F (including the tables 802 to 806 used in a second embodiment) can be referred to as predetermined settings set separately.

### Job List Display Sequence (Basic)

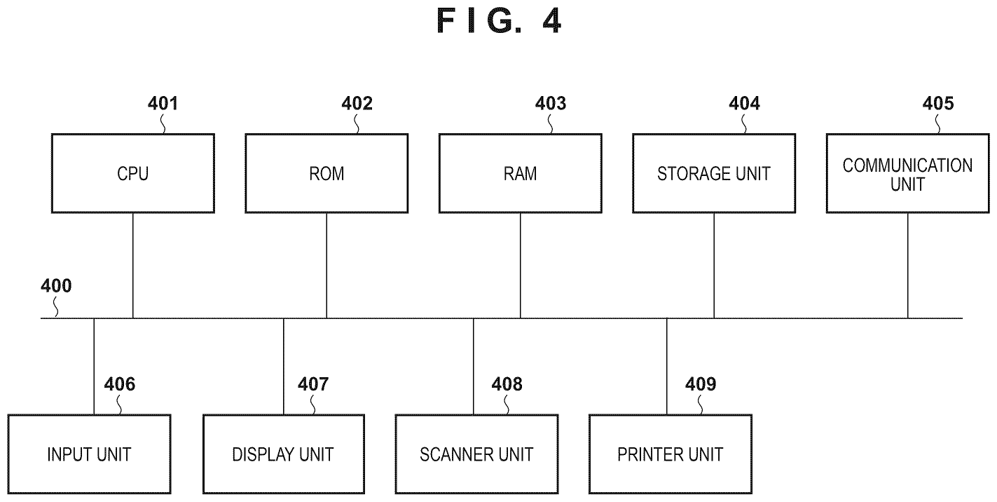

In the configuration of FIG. 1, an example up to output of a print job in the virtual MFP 110 will be described. FIG. 3 illustrates an example of a sequence until a user inputs a print job to the virtual MFP 110, and the user operates the image forming device 120 to display a job list on the image forming device 120 in order to print a certain print job input to the virtual MFP 110. The sequence of FIG. 3 is an example in which the purpose selectable by the user is not particularly restricted.

In order to input a print job to the virtual MFP 110, first, the user inputs user authentication information (e.g., identification information (ID) and password of the user) of the virtual MFP 110 from the client terminal 100. The client terminal transmits a login request to the virtual MFP 110 together with the user authentication information (S301). This operation is also referred to as login. This operation is performed by, for example, accessing a login URL provided by the virtual MFP 110 through a web browser running on the client terminal 100. When the user inputs the user authentication information on the login web page returned from the virtual MFP 110 and performs an operation for transmission, the client terminal 100 transmits the user authentication information to the virtual MFP 110 in S301.

The virtual MFP 110 performs an authentication process based on the received user authentication information (S302). When the authentication is successful, the virtual MFP 110 transmits authorization information (access token) to the client terminal 100 (S303). At the same time, the virtual MFP 100 transmits a web page (screen information) for selecting the print job and the purpose to the client terminal 110. When the client terminal 100 accesses the virtual MFP 110, the access token received in S303 is also transmitted, and the access is permitted when the access token is authorized.

When there is a print job to be transmitted to the virtual MFP 110 in the client terminal 100, the user selects purpose information (or purpose tag) indicating the purpose (S304). For selection of the print job, for example, the user may select the location, and select one or a plurality of files (print job files) of a desired print job from the selected location (e.g., a folder). The purpose of the selected print job may be selected from the purposes indicated by the purpose information set in the purpose information table 801 in the virtual MFP 110. For example, the purposes registered in the purpose information table 801 may be displayed in a pull-down menu for purposes in the web page provided by the virtual MFP 110, and the user may select one of the purposes. The client terminal 100 transmits the print job file selected by the user in S304 and the purpose information of the purpose selected by the user in association with the print job file to the virtual MFP 110 (S305). The print job is registered in the virtual MFP 110 by the procedure up to step S305.

The virtual MFP 110 saves the received print job file and the purpose information in association with each other in the data saving unit 205. With respect to the print job registered in the virtual MFP 110, the charging details and the total are held for each charging destination to be charged to the charging destination associated with the purpose tag selected for the print job, and the charging destination is billed and settled by payment.

Next, in order to acquire a job list in the virtual MFP 110, first, the user inputs authentication information for logging into the virtual MFP 110 in the image forming device 120 (S306), and the image forming device 120 transmits the authentication information to the virtual MFP 110 (S307).

The virtual MFP 110 performs an authentication process based on the received authentication information (S308). When the authentication is successful, the virtual MFP 110 transmits authorization information (access token) to the image forming device 120 (S309). Hereinafter, similarly to the client terminal 100, when the image forming device 120 accesses the virtual MFP 110, an access token is transmitted to be authorized, but description thereof will be omitted.

The image forming device 120 that has received the authorization information requests a job list with respect to the virtual MFP 110 (S310). In response to the request for the job list, the virtual MFP 110 transmits a list of all the print jobs input by the logged-in user as a job list to the image forming device 120 (S311). The job list is displayed on a display panel or the like of the image forming device 120, and the user selects a print job to be executed from the job list and makes a request to the virtual MFP 110 (S312). Accordingly, the print job requested of the virtual MFP 110 by the image forming device 120 is downloaded (S313) and executed by the image forming device 120 (S314).

When the print job is completed, the image forming device 120 transmits a job completion notification to the virtual MFP 110 (S315). The virtual MFP 110 performs a charging process for the executed print job (S316). At this time, the virtual MFP 110 performs the charging process according to the purpose selected by the user of the print job input by the user. For example, the image forming device 120 transmits, to the virtual MFP 110, log information including information affecting the charging amount of money, such as the number of printed pages, color/black-and-white distinction, and size, together with the job completion notification of the print job. The virtual MFP 110 obtains the amount of money based on the information such as the number of pages included in the received log information and the unit price, specifies the charging destination corresponding to the purpose tag associated with the print job based on the purpose information table 801, and cumulatively charges the obtained amount of money to the specified charging destination. Further, statistical process may be performed based on the log information. Alternatively, in response to the job completion notification, the virtual MFP 110 may calculate the amount of money by obtaining the number of pages for the above-described size and each color/black-and-white related to the executed print job. The obtained charging amount is settled according to the payment. The amount of money for each charging destination may be used for billing or may be provided to the charging destination.

Through such processing, the print job input by the user to the virtual MFP 110 can be output from the image forming device 120 that can use the virtual MFP 110, for example, a multifunction peripheral or a printer.

In the example of FIG. 3, the purposes that the user can select are not further restricted as long as they are registered in the virtual MFP 110. Therefore, the user can select any registered purpose, and a charging amount is obtained for each purpose.

As described above, when the purpose is designated in association with the print job at the time of upload of the print job to the virtual MFP 110, charging and counting can be performed for each purpose regardless of the account logged in by the user.

According to the configuration and procedure of the present embodiment described above, the user can select the purpose from among the purposes registered in advance. Thus, charging management can be performed for each selected purpose.

### Second Embodiment

Next, as a second embodiment, an example in which a more appropriate purpose can be set by the virtual MFP 110 further limiting the purposes that can be selected by the user will be described. The configuration of the system is similar to that of the first embodiment. However, a terminal-specific purpose management table 802, a job execution restriction setting 803, a device administrator table 804, a purpose restriction setting 805, and an outside-organization restriction setting 806 in FIGS. 8B through 8F are referred to in the present embodiment.

### Job List Display Sequence

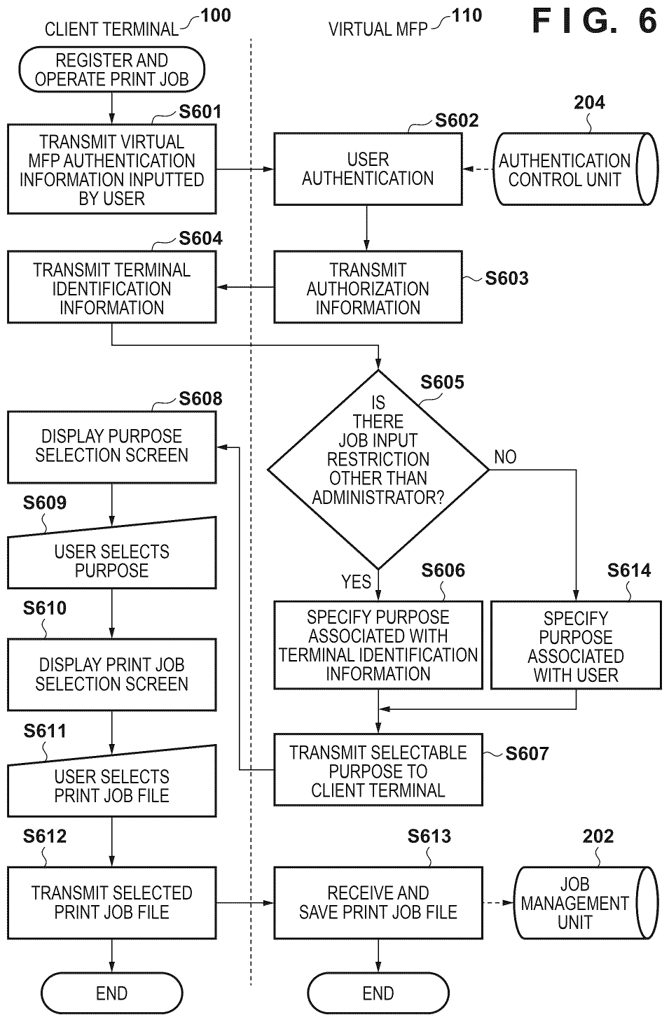

FIG. 5 shows a sequence example up to job display in the system configuration of FIG. 1. In the sequence of FIG. 5, unlike FIG. 3, the virtual MFP 110 transmits the purpose setting information indicating the purposes selectable by the user to the client terminal 100, thereby limiting the purposes of the print job selectable by the user.

As a premise, it is assumed that the user account of the virtual MFP 110 is already issued to the user, and the purpose can be selected as a print job for business use of an organization (or tenant) to which the user belongs or a print job for personal use. For example, at the time of user registration to the virtual MFP 110, purposes selectable for each client terminal are registered as user information in addition to the authentication information such as a user ID and a password. In a case where the purposes that can be selected are restricted, the user can select one of the registered purposes after login.

As an example of the registration, FIG. 8B illustrates a terminal-specific purpose management table 802. The terminal-specific purpose management table 802 is a table in which identification information (terminal identification information) of a client terminal registered in the virtual MFP 110 is associated with purposes that can be associated with a print job input from the client terminal. One or a plurality of purposes can be associated with one piece of terminal identification information. Furthermore, a client terminal that is not registered in the terminal-specific purpose management table 802 is not associated with any purpose. As for the print job input from such a client terminal, as in the first embodiment, the purposes registered in the purpose information table 801 becomes selectable purposes.

In addition, in the image forming device managed by the organization, it is assumed that the administrator of the organization has set in advance whether or not to permit the display of a print job that was input to the virtual MFP 110 and in which a purpose other than that of the organization is set. For example, in the case of a setting permitting it, print jobs for which a purpose other than the purposes associated with the administrator of the image forming device is set can also be displayed as a job list and those print jobs can be executed on the image forming device 100. As an example of the setting, FIG. 8C illustrates the job execution restriction setting 803. In the job execution restriction setting 803, whether or not to permit execution of a print job for which a purpose other than the purpose associated with the administrator of the device is designated is set for each device identification information item. Note that, although permission or non-permission is set here, it may be a list of either permitted devices or non-permitted devices.

In addition, the device identification information and the identification information of the administrator are registered in the device administrator table 804 of FIG. 8D. By referring to this, an administrator of the device can be specified.

Furthermore, it is assumed that the administrator of the organization performs in advance the input restriction setting as to whether or not the organization to which the user belongs restricts the input of print jobs other than those whose purpose is of the organization when the user inputs a print job to the virtual MFP 110. An example of this setting is illustrated in the purpose restriction setting 805 of FIG. 8E. In this setting, whether or not to restrict the input of a print job is set for each administrator. For example, if an administrator is defined for each terminal, the administrator can restrict input of a print job, in which a purpose that is not associated with the administrator is designated, to the virtual MFP 110 for the terminal under the management. Note that in the purpose restriction setting 805, the presence or absence of restriction is set for each administrator, but the presence or absence of restriction may be set for each terminal identification number. In this case, the setting may be performed by an administrator who manages the terminal. These set values are held by the virtual MFP 110.

In FIG. 5, processing and transmission/reception of data and the like by each of the image forming device 120, the virtual MFP 110, and the client terminal 100 are illustrated. Processing by each of the image forming device 120, the virtual MFP 110, and the client terminal 100 is implemented by at least one CPU 401 thereof executing at least one program stored in at least one memory such as the RAM 403.

In order to input a print job to the virtual MFP, first, the user inputs the user authentication information (e.g., user ID and password) of the virtual MFP 110 from the client terminal 100, and the client terminal transmits the same to the virtual MFP 110 (S501).

The virtual MFP 110 performs an authentication/authorization process based on the received information (S502). At this time, an organization to which the user belongs is also specified from the identification information of the user. The organization to which the user belongs can be specified by, for example, an organization name included in the user identification information. The organization name is the same as or corresponded with the administrator identification information. When the user is authorized, the virtual MFP 110 transmits authorization information (access token) to the client terminal 100 (S503).

Next, the virtual MFP 110 requests the client terminal 100 for terminal identification information (S504). The client terminal 100 requested for the terminal identification information transmits its own terminal identification information to the virtual MFP 110 (S505).

The virtual MFP 110 refers to the purpose restriction setting 805 in FIG. 8E to determine whether or not the restriction on the input of the print job according to the purpose is set (S506). At this time, information of purposes corresponding to the administrator identification information of the organization to which the logged-in user (referred to as a logged-in user) belongs may be specified with reference to the purpose restriction setting 805.

In a case where it is determined that there is a restriction on the purpose, the virtual MFP 110 refers to the purposes of the print job selectable by the user in the client terminal 100 in the terminal-specific purpose management table 802 of FIG. 8B (S507). At this time, the purpose associated with the terminal identification information is specified from the terminal-specific purpose management table 802, and the specified purpose is specified as a purpose selectable in the client terminal 100.

On the other hand, in a case where it is determined in S506 that a restriction on the input of a print job according to the purpose is not set, in S507, for example, the purpose information associated with the organization (administrator) to which the user belongs is specified in the purpose information table 801 of FIG. 8A. The specified purpose information may be the purposes selectable in the client terminal 100. The purpose information associated with the organization to which the user belongs is also referred to as purpose information associated with the user.

Next, purposes associated with the terminal identification information received in S507 or the purpose information associated with the logged-in user is transmitted as options to the client terminal 100 (S508). This transmission may be performed with the transmission of the UI screen, and the UI may display selectable purposes in a pull-down manner. Here, when the restriction on the input of the print job according to the purpose is not set, or when the received terminal identification information is not registered in the terminal-specific purpose management table 802, the purposes that can be selected may be all the purposes registered in the purpose information table 801.

The client terminal 100 presents the print job purposes selectable by the user based on the received information, and the user selects the print job file and the purpose of the print job file (S509). Note that in the following steps, the print job refers to a print job input to the virtual MFP 110 by the logged-in user, and other print jobs are not taken into consideration. At this time, when there is only one purpose of the print job selectable by the user in the client terminal 100 in S507, the selection of the purpose may be omitted. The client terminal 100 transmits the print job selected by the user and the purpose information (purpose tag) indicating the purpose to the virtual MFP 110 (S510). A print job is input to the virtual MFP 110 through the above procedure.

Next, for the image forming device 120 to acquire a job list from the virtual MFP 110, first, the user inputs authentication information for logging into the virtual MFP in the image forming device 120 (S511). The image forming device 120 transmits the input authentication information to the virtual MFP 110 (S512). The virtual MFP 110 performs an authentication/authorization process based on the received information (S513). When the authentication or the authorization is successfully performed, the virtual MFP 110 transmits authorization information (access token) to the image forming device 120 (S514).

The image forming device 120 that has received the authorization information transmits device identification information that can uniquely specify the image forming device 120 to the virtual MFP 110 (S515).

The virtual MFP 110 refers to the job execution restriction setting 803 in which the job execution restriction setting associated with the received device identification information is registered (S516). In the job execution restriction table 803, a device identification number and permission or restriction (prohibition) of execution of a print job for a purpose other than the purposes associated with the administrator of the device by the device are designated. When determined that the execution is permitted, the process branches to S517. When not permitted, the print job that can be executed by the image forming device 120 is limited to the print job for which a purpose associated with the administrator of the image forming device 120 is designated. In this case, the process branches to S518.

In S517, the setting as to whether the printing in the outside-organization image forming device of the print job for which a purpose other than the purpose associated with the administrator of the image forming device 120 is designated is permitted is confirmed with reference to the outside-organization restriction setting 806. In the outside-organization restriction setting 806 illustrated in FIG. 8F, whether or not execution in the outside-organization image forming device of a print job for which a purpose other than the purposes associated with an administrator of the device is designated is permitted is set in association with the administrator identification information. Here, “outside-organization” means that the image forming device 120 is not installed in a region occupied by the administrator, for example, and if the administrator is a company, for example, it is installed outside the company. Here, the image forming device 120 is assumed to be an outside-organization image forming device. Whether or not the image forming device is outside the organization can be determined by, for example, specifying the installation location managed in correspondence with the device identifier.

In step S518, the virtual MFP 110 extracts, as a job list, only a print job associated with a purpose tag permitted to be executed from the print jobs held by the virtual MFP 110 and input by the logged-in user based on the set values referred to in steps S516 and S517. When execution is permitted, this means that execution on the image forming device 120 to which the user is logged-in is permitted.

For example, consider a case where it is determined in S516 that execution of a print job for a purpose other than the purposes associated with the administrator of the image forming device 120 is restricted. In this case, in S518, a job list of print jobs in which a purpose associated with the administrator of the image forming device 120 is designated among the print jobs input by the logged-in user is created.

Furthermore, for example, consider a case where it is determined in S516 that execution of a print job for which a purpose other than the purposes associated with the administrator of the image forming device 120 is designated is permitted. In this case, consider a case where it is determined in S517 that printing in an outside-organization image forming device of a print job for which a purpose other than the purposes associated with the administrator of the image forming device 120 is designated is permitted. In this case, in S518, first a job list of print jobs in which a purpose associated with the administrator of the image forming device 120 is designated among the print jobs input by the logged-in user is created. In addition, among the print jobs input by the logged-in user, a print job in which a purpose other than the purposes associated with the administrator of the image forming device 120 is designated is also added to the job list.

On the other hand, consider a case where it is determined in S517 that printing in an outside-organization image forming device of a print job for which a purpose other than the purposes associated with the administrator of the image forming device 120 is designated is restricted. In this case, in S518, a job list of print jobs in which a purpose associated with the administrator of the image forming device 120 is designated among the print jobs input by the logged-in user is created. That is, it is similar to the case where it is determined in S516 that the execution of a print job for which a purpose other than the purposes associated with the administrator of the image forming device 120 is designated is restricted.

The virtual MFP 110 transmits the job list generated in S518 to the image forming device 120 (S519). In the image forming device 120, a user can select a print job from the job list and give an instruction to execute the selected print job. A request for downloading the print job selected in response to the instruction is transmitted to the virtual MFP 110, and the print job is downloaded from the virtual MFP 110 to the image forming device 120 and executed accordingly.

By performing such process, it becomes possible to control the job list displayed on the image forming device owned by the organization based on the purpose associated with the print job.

### Job Input Flow

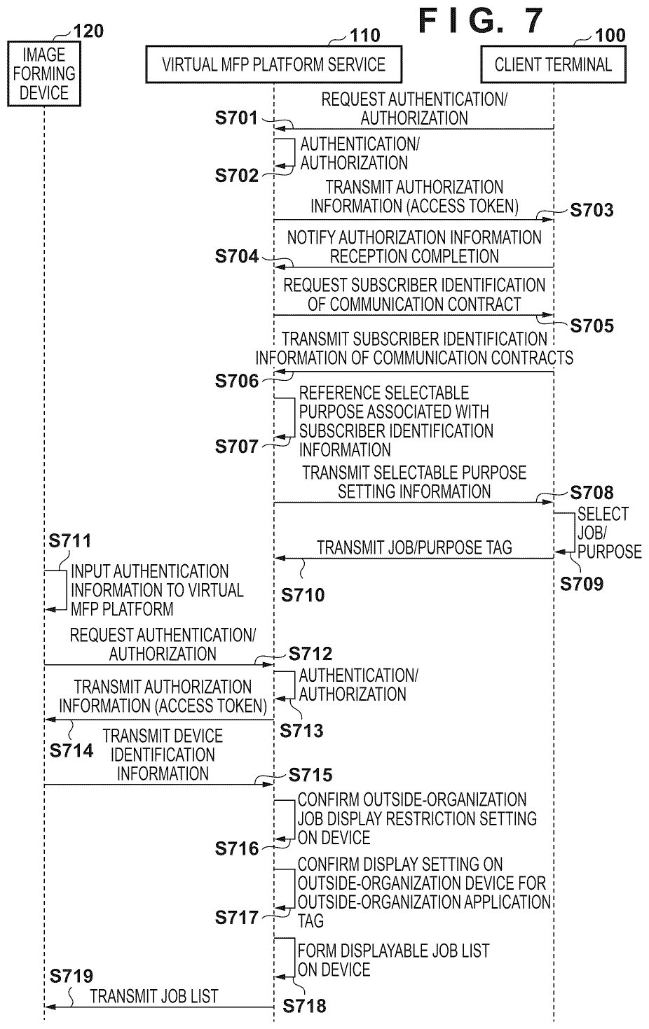

FIG. 6 is a flowchart of each of the client terminal 100 and the virtual MFP 110 until the user operates the client terminal 110 to display the job list in the system configuration of FIG. 1. This flow corresponds to S501 to S510 in FIG. 5. The processing of each of the client terminal 100 and the virtual MFP 110 is achieved by each CPU 401 serving as an execution subject executing a program stored in a memory such as the RAM 403.

The user inputs authentication information for logging into the virtual MFP via a user interface such as an input unit of the client terminal 100, and transmits the authentication information to the virtual MFP 110 in S601.

In S602, the virtual MFP 110 performs user authentication by communicating with the authentication control unit 204 using the received authentication information.

When the authentication is successful, the virtual MFP 110 transmits authorization information (access token) to the client terminal 100 in S603.

The client terminal 100 that has received the authorization information transmits the terminal identification information to the virtual MFP 110 in S604.

In S605, the virtual MFP 110 refers to the purpose restriction setting 805 and determines whether or not the restriction on the input of the print job according to the purpose is set. What is referred to at this time is, for example, administrator identification information of an organization to which the logged-in user belongs, and restriction information corresponding thereto may be specified with reference to the purpose restriction setting 805. When the input restriction of the print job according to the purpose is set, S606 is executed. When the input restriction setting is not set, the process branches to S614.

In S606, the virtual MFP 110 acquires the purpose information (purpose tags) associated with the received terminal identification information from the terminal-specific purpose management table 802.

On the other hand, in S614, the virtual MFP 110 specifies and acquires the purpose information associated with the logged-in user. The user identification information can be specified for the logged-in user, and the administrator identification information of the organization to which the user belongs can be specified therefrom. The purpose information corresponding to the administrator identification information may be specified in the purpose information table 801, and the specified purpose information may be used as the purpose information associated with the logged-in user.

In S607, the virtual MFP 110 provides the purpose tags acquired in S606 or S614 as options of settable purposes in association with the print job to be input in the client terminal 100. For example, a user interface screen may be provided to the client terminal 100, and on the user interface screen, it may be provided in a form in which the purpose can be selected from pull-down or the like.

In S608, the client terminal 100 displays a screen for selecting a purpose received from the virtual MFP 110.

In S609, the client terminal 100 accepts and stores the tag selected by the user as a tag associated with the print job to be input to the virtual MFP 110.

In S610, the client terminal 100 displays a screen for selecting a print job. At this stage, the print job to be input is saved in the client terminal 100, and merely needs to be selected therefrom. Alternatively, a print job saved in other remote server or the like may be selected.

In S611, the client terminal 100 accepts the selection of the print job by the user. Then, in S612, for example, in response to a transmission instruction from the user, the selected print job is transmitted to the virtual MFP 110 in association with the selected purpose. At this time, if a plurality of print jobs are selected, all the selected print jobs may be transmitted in association with the purpose selected in S609.

In S613, the virtual MFP 110 receives and saves the print job transmitted from the client terminal 100. The saved print job can be downloaded and executed in accordance with an instruction from the image forming device 120.

As described above, according to the present embodiment, when the user inputs the print job to the virtual MFP, the purpose of use of the print job can be appropriately set according to the terminal that inputs the print job.

Note that the determination of S506 in FIG. 5 may be performed prior to S504. In that case, if the job input restriction according to the terminal is not performed, S506 and S507 may be skipped.

When it is determined in S605 that there is no restriction on the input of the print job of a user other than the administrator, the purposes associated with the user are not set as options of the purpose, and all the purposes registered in the purpose information 801 may be set as options of the purpose that can be selected by the user.

### Third Embodiment

A third embodiment of the present invention will be described. In the third embodiment, in addition to the second embodiment, an example of a virtual MFP including a job input unit configured to identify subscriber information communicated by a terminal when a print job is input to the virtual MFP and set a purpose associated with the print job to an appropriate one will be described.

Even if a client terminal for submitting (also referred to as inputting or registering) a print job to the virtual MFP 110 can be uniquely specified, it may not be determined that the submission of the print job from that terminal is for business use. For example, the client terminal is a mobile terminal in which a plurality of SIM cards are inserted, and it may be possible to switch subscriber information used for communication. The subscriber information used for communication is information related to a contract with a carrier for each SIM, and may include, for example, identification information of a carrier and identification information of a subscriber of the carrier in the case of contract with a different carrier.

According to the third embodiment, even when a terminal that submits a print job performs communication under two different communication contracts for business use and personal use, the purpose of the print job can be designated when it is determined that the communication is for business use.

### Job List Display Sequence

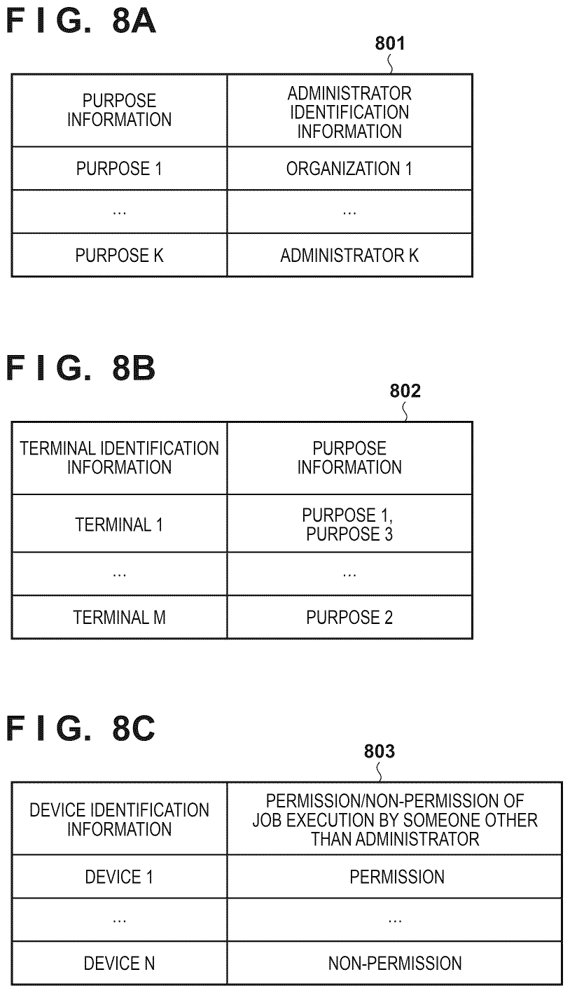

FIG. 7 shows a sequence up to job display in the system configuration of FIG. 1. Note that, as a premise, it is assumed that the user has issued a user account of the virtual MFP, and the user can select a purpose as a print job for an organization to which the user belongs and a personal use. Assume that a user or an administrator of an organization registers, in the virtual MFP in advance, subscriber information for performing communication on a terminal of the client terminal 703 used by the user to submit a print job. In addition, in the image forming device managed by the organization, it is assumed that the administrator of the organization has set in advance whether or not to permit the display of the print job set for the purpose other than the organization input to the virtual MFP. Furthermore, it is assumed that the administrator of the organization performs in advance the setting on whether or not the organization to which the user belongs restricts the input of a print job whose purpose is other than the purpose of the organization when the user inputs a print job to the virtual MFP. Also in the present embodiment, the flow of FIG. 7 is realized by at least one CPU of each of the image forming device 120, the virtual MFP 110, and the client terminal 100 executing at least one program stored in at least one memory such as the RAM 403.

Steps S701 to S703 are equivalent to steps S501 to S503 in the first embodiment. In S704, the client terminal 100 transmits a reception completion notification of the authorization information to the virtual MFP 110. Note that the reception completion notification of the authorization information may be similarly transmitted in FIG. 5.

Next, the virtual MFP 110 requests the client terminal 100 for the subscriber information of the communication contract (S705), and the client terminal 100 transmits the subscriber identification information (S706). The subscriber identification information is information for the mobile terminal to perform communication, and indicates information that can uniquely specify the SIM card. The image MFP 110 saves a table or the like of the subscriber identification information and the purpose information associated therewith set in advance. The virtual MFP 110 refers to the table and the like to specify the purposes of the print job that are associated with the received subscriber identification information and that can be selected by the user in the client terminal 100 (S707). Then, the purpose information indicating the specified purposes is transmitted to the client terminal 100 (S708).

The client terminal 100 presents options of print job purposes selectable by the user on a UI screen or the like based on the received purpose information. Then, the user selects a print job file saved in the client terminal 100 or the like, and selects a purpose to be designated for the print job file from the options of the purpose (S709). At this time, when there is only one purpose of the print job selectable by the user in the client terminal 100 in S707, the selection of the purpose may be omitted. The client terminal 100 transmits the print job selected by the user and the purpose tag indicating the purpose to the virtual MFP 110 (S710).

Steps S711 to S719 are similar to steps S511 to S519 in the first example.

By performing such process, even if the terminal that submits the print job communicates under two different communication contracts of business use and personal use, when determined that the print job is submitted using the communication for business use, the purpose of the print job can be designated.

Note that the terminal identification information of the client terminal 100 in the first embodiment and the subscriber identification information in the second embodiment can be collectively referred to as identification information related to a terminal device. In this case, the identification information related to the terminal device includes the identification information of the terminal device itself and the subscriber identification information with the carrier (communication carrier) of the terminal device.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-052129, filed Mar. 27, 2024 which is hereby incorporated by reference herein in its entirety.

What is claimed is:

1. An information processing apparatus comprising:
a communication device;
at least one memory storing instructions; and
at least one processor that is in communication with the at least one memory and that, when executing the instructions, cooperates with the at least one memory to execute processing, the processing including
holding purpose information associated with identification information related to a terminal device;
receiving the identification information related to the terminal device from the terminal device;
transmitting purpose information associated with the received identification information to the terminal device as a purpose selectable in the terminal device; and
receiving and storing, from the terminal device, a print job associated with a selected purpose.

2. The information processing apparatus according to claim 1, wherein
the identification information related to the terminal device is identification information of the terminal device.

3. The information processing apparatus according to claim 1, wherein
the identification information related to the terminal device is subscriber identification information of the terminal device with a communication carrier.

4. The information processing apparatus according to claim 1, wherein
a user interface screen is provided for the terminal device, and the purpose is selected by a user on the user interface screen.

5. The information processing apparatus according to claim 1, wherein
the processing includes,
determining whether or not to restrict the purpose information based on a predetermined setting, wherein
in the transmitting, the purpose information associated with the received identification information is transmitted to the terminal device as a purpose selectable in the terminal device when it is determined to restrict the purpose information.

6. The information processing apparatus according to claim 5, wherein
the processing includes,
receiving a login request including identification information of a user from the terminal device and performing authentication, wherein
in the transmitting, purpose information associated with a logged-in user is transmitted to the terminal device as a purpose selectable in the terminal device when it is not determined to restrict the purpose information.

7. The information processing apparatus according to claim 5, wherein
in the transmitting, purpose information set in advance is transmitted to the terminal device as a purpose selectable in the terminal device when it is not determined to restrict the purpose information.

8. The information processing apparatus according to claim 1, wherein
in response to a request for a job list of print jobs received from an image forming device, a job list of print jobs permitted to be executed by the image forming device among the stored print jobs is transmitted to the image forming device.

9. The information processing apparatus according to claim 8, wherein
in response to a request for a print job received from the image forming device, the print job is transmitted to the image forming device.

10. A non-transitory computer-readable storage medium storing a program that, when loaded and executed on a computer having a communication device, causes the computer to perform processing, the processing comprising:
holding purpose information associated with identification information related to a terminal device;
receiving the identification information related to the terminal device from the terminal device;
transmitting purpose information associated with the received identification information to the terminal device as a purpose selectable in the terminal device; and
receiving and storing, from the terminal device, a print job associated with a selected purpose.

11. An image forming system comprising:
an information processing apparatus;
a terminal device; and
an image forming device; wherein
the information processing apparatus includes,
a communication device;
at least one memory storing instructions; and
at least one processor that is in communication with the at least one memory and that, when executing the instructions, cooperates with the at least one memory to execute processing, the processing including
holding purpose information associated with identification information related to the terminal device;
receiving the identification information related to the terminal device from the terminal device;
transmitting purpose information associated with the received identification information to the terminal device as a purpose selectable in the terminal device; and
receiving and storing, from the terminal device, a print job associated with a selected purpose.

12. A method for processing a print job executed by an information processing apparatus, the information processing apparatus being configured to:
hold purpose information associated with identification information related to a terminal device;
receive the identification information related to the terminal device from the terminal device;
transmit purpose information associated with the received identification information to the terminal device as a purpose selectable in the terminal device; and
receive and store, from the terminal device, a print job associated with a selected purpose.
